(19) United States
(12) Patent Application Publication
(10) Pub. No.: US 2006/0222007 A1
(43) Pub. Date: Oct. 5, 2006

(54) RPR ring network system

(75) Inventors: Yoshiyuki Karakawa, Yokohama (JP); Yuji Kuroki, Yokohama (JP); Junichi Kawaguchi, Yokohama (JP)

Correspondence Address: BINGHAM MCCUTCHEN LLP, 3000 K STREET, NW, BOX IP, WASHINGTON, DC, 20007, US

(73) Assignee: FUJITSU LIMITED

(21) Appl. No.: 11/191,071

(22) Filed: Jul. 28, 2005

(30) Foreign Application Priority Data
Mar. 31, 2005 (JP) JP2005-102448

(51) Int. Cl. H04J 3/22; H04L 12/56; H04L 12/26; H04L 1/00; H04L 12/28; H04J 3/16

(52) U.S. Cl. 370/468; 370/229; 370/424

(57) ABSTRACT

Provided is an RPR ring network system including: a plurality of RPR station devices; and a ring for interconnecting the plurality of RPR station devices, in which a section between adjacent RPR station devices is defined as a section of the ring, a bandwidth different from bandwidths of other sections are allocated to at least one section, and each of the RPR station devices transmits a frame, in the case of transmitting the frame to the other RPR station device through the ring, by a transmission bandwidth with a minimum value of a bandwidth allocated to a section through which the frame flows set as an upper limit.

### BACKGROUND OF THE INVENTION

1. Field of the Invention

The present invention relates to a resilient packet ring (RPR) network system.

2. Description of the Related Art

In communications field, a conspicuous increase in traffic of the Internet Protocol (IP) communications have been accompanied by recent popularization of the Internet. The IP communications have hitherto been mainly directed to data communications. Thus, real-time communications are not so required as compared with voice communication or the like, and a relatively large margin has been allowed for a time necessary for recovery from a failure.

However, as a result of a steady increase in demand for the IP communication, an application range of the IP communications have been widened. Simultaneously, demand for reliability of a network has been growing. An RPR technology has recently been established, whereby high reliability can be secured even in the IP communications.

The RPR is a technology developed as a ring network optimized for data traffic of the Ethernet (registered trademark) or the like and satisfying reliability for a wide area network (WAN). According to this technology, the Ethernet frame is encapsulated in an RPR frame transferred through the RPR ring network.

FIGS. 8 and 9 are diagrams showing a conventional frame transmission/reception system in the RPR. FIGS. 8 and 9 show an RPR ring network including a SONET ring (RPR ring) 20 to which SONET devices 21, 22, 23, and 24 are connected, and RPR devices 11 and 12 respectively connected to the SONET devices 21 and 22.

The SONET ring 20 includes an outer ringlet (ringlet 0), and an inner ringlet (ringlet 1). In the ringlet 0, the RPR frames flow clockwise (route 20-1). In the ringlet 1, the RPR frames flow counterclockwise (route 20-2). FIG. 8 shows a data flow from the RPR device 11 to the RPR device 12. FIG. 9 shows a data flow from the RPR device 12 to the RPR device 11.

Usually, the same signal (RPR frame) is sent to the ringlets 0 and 1 (routes 20-1 and 20-2), and the RPR device of a reception side selects one of the signals received from the routes 20-1 and 20-2 and fetches (takes) in one of the signals. Thus, in order to increase a communication capacity between the RPR devices 11 and 12, for example, all bandwidths between the SONET devices adjoining on the SONET ring 20 had to be set equal.

Because of this constraint, to increase a bandwidth (communication capacity) of a certain section (between SONET devices) of the SONET ring 20, bandwidths of all sections had to be increased. For example, as shown in FIG. 7, to change a bandwidth between the SONET devices 21 and 22 from OC-48 (2.4 Gbps (giga bit per second)) to OC-192 (9.6 Gbps), bandwidths of the remaining sections (between SONET devices 22 and 23, SONET devices 23 and 24, and SONET devices 24 and 21) also had to be changed to OC-192.

Accordingly, to increase the bandwidth of a certain section of the SONET ring, physical lines (optical fibers) corresponding to the increase had to be prepared for all the sections. Thus, increasing the bandwidth of a certain section has driven up costs. Additionally, in a case where there is no need to use increased physical capacities of the other sections, unnecessary bandwidths have been generated as shown in FIG. 10.

The following documents are available concerning prior arts of the present invention.

[Patent document 1] JP 2003-324473 A

### SUMMARY OF THE INVENTION

An object of the present invention is that it is possible to provide a technology in which a bandwidth (communication capacity) of a certain section of a ring constituting an RPR network can be set higher than those of other sections without requiring to increase physical capacities of the other sections.

To achieve the above-mentioned object, the present invention employs the following configuration.

That is, the present invention provides an RPR ring network system including: resilient packet ring (RPR) station devices; and a ring for interconnecting the RPR station devices, wherein a section between adjacent RPR station devices is defined as a section of the ring, at least one section has a bandwidth different from bandwidths of other sections, and each of the RPR station devices determines a transmission bandwidth for transmitting frames to one of the RPR station devices through the ring so that an upper limit of the determined transmission bandwidth becomes a minimum value of a bandwidth allocated to each section that the frames will flow.

The RPR ring network system according to the present invention may be preferably configured such that the at least one of the sections has a physical capacity larger than those of the other sections, and each section has a bandwidth allocated within a range that a physical capacity of each section is an upper limit of the bandwidth.

The RPR ring network system according to the present invention may be preferably configured such that all the sections have physical capacities equal to one another, and each section has a predetermined bandwidth logically allocated within a range that the physical capacity becomes an upper limit of the predetermined bandwidth.

The RPR ring network system according to the present invention may be preferably configured such that the ring includes two ringlets for transmitting frames in opposite directions, and when frames containing identical data are sent to the two ringlets, each RPR station device, when sending frames each including the same data to the two ringlets, determines a transmission bandwidth of the frames sent each ringlet, based on a minimum value of a bandwidth allocated to each section of each ringlet through which the frames will flow.

The RPR ring network system according to the present invention may be preferably configured such that a part or all of areas common to all the sections, which is included in the bandwidth allocated to each section, are controlled based on a fairness algorithm.

The RPR ring network system according the present invention may be preferably configured such that, an area excluding areas common to all the sections, which is included in the bandwidth allocated to each section, is defined as a bandwidth to guarantee a bandwidth secured beforehand.

According to the present invention, it is possible to provide a technology in which a bandwidth (communication capacity) of a certain section of a ring constituting an RPR ring network can be set higher than those of other sections without requiring to increase physical capacities of the other sections.

### BRIEF DESCRIPTION OF THE DRAWINGS

FIG. 1 is a diagram showing a configuration example of an RPR ring network system according to a first embodiment of the present invention;

FIG. 2 is a diagram showing an example of allocating bandwidths of sections of an RPR ring network shown in FIG. 1;

FIG. 3 is a diagram showing a configuration example of an RPR station device (station) , and formats of frames treated in the RPR station device;

FIG. 4 is an explanatory diagram of an RPR frame format;

FIG. 5 is a diagram showing a configuration example of a bandwidth control unit of an RPR frame;

FIG. 6 is a diagram showing a configuration example of an RPR ring network system according to a second embodiment of the present invention;

FIG. 7 is a diagram showing an example of bandwidths logically allocated to sections of RPR ring network shown in FIG. 6;

FIG. 8 is a diagram showing an example of an RPR ring network;

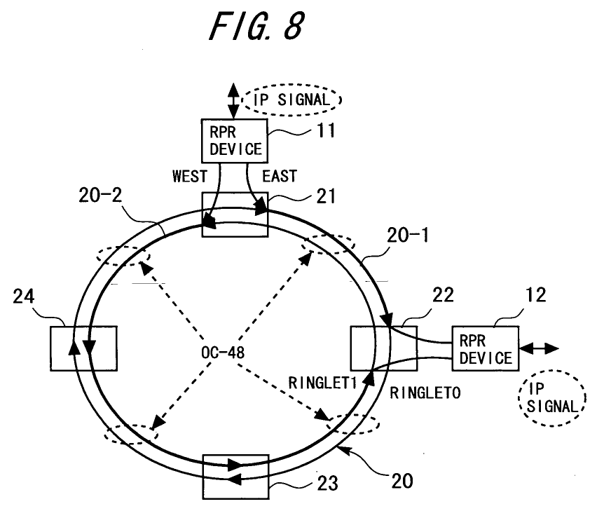

FIG. 9 is a diagram showing an example of an RPR ring network; and

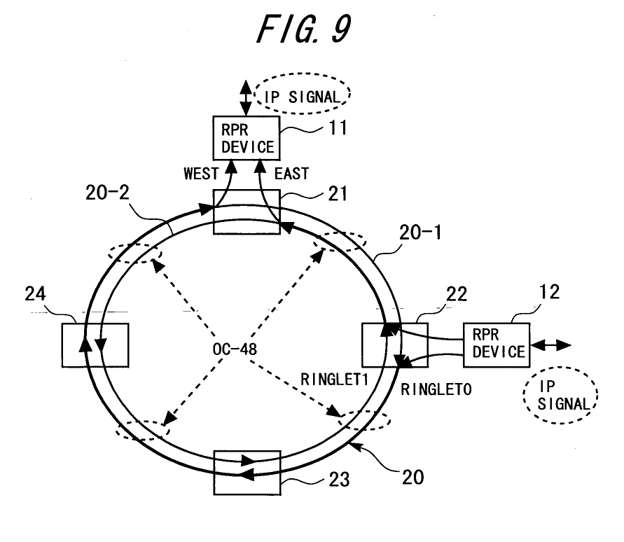

FIG. 10 is a diagram showing a problem (unnecessary bandwidth) of a conventional art.

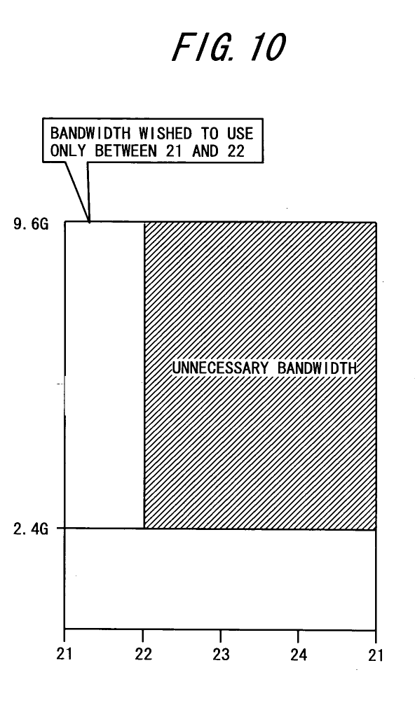

### DESCRIPTION OF THE PREFERRED EMBODIMENTS

Hereinafter, the preferred embodiments of the present invention will be described with reference to the drawings. Configurations of the embodiments are examples and do not limit a scope of the present invention.

[First Embodiment]

<Configuration of RPR network>

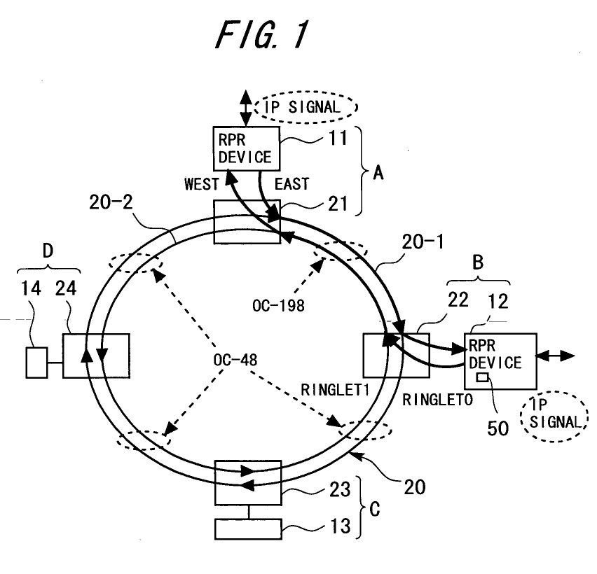

FIG. 1 is a diagram showing a configuration example of an RPR network system according to a first embodiment of the present invention. Referring to FIG. 1, the RPR network system is configured as follows. A plurality of synchronous optical network (SONET) devices 21, 22, 23, and 24 are interconnected through an RPR SONET ring 20 (referred to as “ring 20” hereinafter).

The ring 20 includes two ringlets (ringlets 0 and 1) as at least two (duplex) ringlets. The ringlet 0 constitutes a route 20-1 for transferring SONET frames clockwise (EAST direction). The ringlet 1 constitutes a route 20-2 for transferring the SONET frames counterclockwise (WEST direction).

An RPR device is connected to each of the SONET devices 21, 22, 23, and 24. FIG. 1 shows an RPR device 11 connected to the SONET device 21, an RPR device 12 connected to the SONET device 22, an RPR device 13 connected to the SONET device 23, and an RPR device 14 connected to the SONET device 24.

The SONET device and the RPR device constitute an RPR station device (RPR station: also called “RPR node” or “node”. Referred to as “station” hereinafter). FIG. 1 shows a station A constituted of the SONET device 21 and the RPR device 11, a station B constituted of the SONET device 22 and the RPR device 12, a station C constituted of the SONET device 23 and the RPR device 13, and a station D constituted of the SONET device 24 and the RPR device 14.

The RPR device is a device for executing processing of a layer 2 (data link layer). Especially, the RPR device executes RPR frame generation or the like as processing of the RPR for supporting a MAC layer in the layer 2. The SONET device executes generation of a SONET frame storing the RPR, sending (“adding”)/fetching (“dropping”) to or from the ringlet, or the like, according to a SONET for supporting a layer 1 (physical layer)

Each RPR device is connected to an external network to receive signals (e.g., IP signal) from the external network, or send the IP signals to the external network. Upon reception of the IP signals (e.g., Ethernet frame (referred to as “LAN frame” hereinafter)) from the external network, the RPR device generates an RPR frame in which the LAN frame is encapsulated, and inputs the RPR frame to the SONET device.

The SONET device generates a SONET frame storing an RPR frame from the RPR device, and sends (“adds”) the SONET frame to at least one of the ringlets 0 and 1. The SONET device takes out, from the ringlet 0 or 1, the SONET frame flowing therethrough, and judges whether a destination of the SONET frame is its self-device (SONET device itself).

In this case, if the destination is the self-device, the SONET device fetches (“drops”) the SONET frame into itself. On the other hand, if the destination of the SONET frame is not the self-device, the SONET device returns the SONET frame again to the original ringlet. Accordingly, the SONET frame flows toward a next SONET device.

After the SONET frame has been fetched into the SONET device, the RPR frame is taken out of this SONET frame, and input to the RPR device. The RPR device takes out the LAN frame from the RPR frame, and sends the LAN frame to the external network. The RPR ring network thus configured can be used as a relay network for interconnecting external networks.

in the RPR ring network shown in FIG. 1, a section between adjacent stations is defined asa section (station section) composing of the SONET ring 20. In the example shown in FIG. 1, sections between the stations A and B, between the stations B and C, between the stations C and D, and between the stations D and A are defined as sections of the ring 20. Hereinafter, for convenience of explanation, these sections will be called “section 1”, “section 2”, “section 3”, and “section 4”.

In the example shown in FIG. 1, in the section 1, the SONET devices 21 and 22 are interconnected through a physical line (optical fiber) of OC-198 (9.6 Gbps) accommodating the ringlet 0/1. On the other hand, in the sections 2, 3, and 4, the SONET devices are interconnected through a physical line of OC-48 (2.4 Gbps) accommodating the ringlet 0/1. The OC-198 and the OC-48 are digital hierarchies (transmission speeds: called “communication capacities” or “bandwidths”) defined by the SONET.

The RPR ring network shown in FIG. 1 is based on the assumption that a physical line capacity of a certain section (section 1) of the ring 20 in which the OC-48 is applied to all the sections is changed (increased) to the OC-198.

In this case, a bandwidth whose upper limit is 9.6 Gbps can be allocated to the SONET frame (simply referred to as “frame” hereinafter) flowing through the section 1. On the other hand, a physical line capacity of each of the sections 2 to 4 is 2.4 Gbps. Thus, a bandwidth whose upper limit is 2.4 Gbps can be allocated to each of the sections 2 to 4.

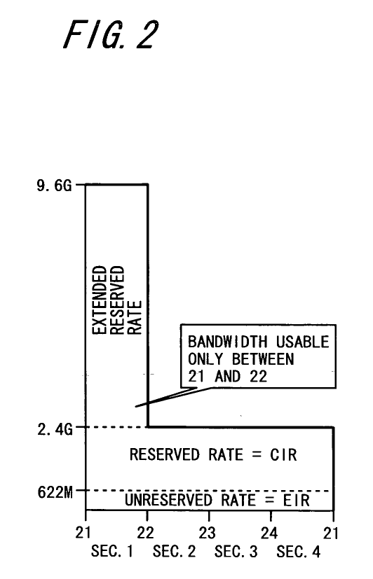

FIG. 2 is a diagram showing an example of allocating bandwidths in the RPR ring network shown in FIG. 1. In the example shown in FIG. 2, a maximum value of a physical capacity of each section is allocated as the bandwidth usable in each section.

That is, the bandwidth of 9.6 Gbps is allocated to the section 1 (between the SONET devices 21 and 22). On the other hand, the bandwidth of 2.4 Gbps is allocated to each of the sections 2 (between the SONET devices 22 and 23), 3 (between the SONET devices 23 and 24), and 4 (between the SONET devices 24 and 21).

The bandwidths allocated to the sections 1 to 4 are classified into an unreserved rate (excess information rate (EIR)) area, a reserved rate (committed information rate (CIR)) area, and an extended reserved rate area.

The reserved rate (CIR) area is an area in which a bandwidth is guaranteed by bandwidth guarantee services for securing beforehand a bandwidth to be used. The extended reserved rate area is an area in which the reserved rate (CIR) area is extended, and treated just as the reserved rate (CIR) area. The unreserved rate (EIR) area is an area controlled by best effort type services, which use a remained bandwidth of entire of the bandwidth of the section exclusive of the reserved bandwidth (including extended reserved bandwidth) as much as permitted by control of a fairness function. The CIR and the EIR are defined in “service classes” of Chapters 5.6.2 of IEEE Draft p 802. 17/D3.3.

The fairness function is a well-known technology for controlling a used bandwidth of each station according to a fairness algorithm so that each of the stations can equitably send (“add”) frames to the ring, which is one of RPR features.

Each of the stations is operated as follows according to the fairness algorithm. For example, upon detection of congestion of the route 20-1 is detected, the station A shown in FIG. 1 notifies a fairness frame regarding the route 20-1 to a next station (station D) on an upstream side by using the route 20-2.

The fairness frame contains information indicating a bandwidth which the station A desires to secure. Upon reception of the fairness frame, the station D adjusts its own bandwidth to be used so as not to exceed the notified bandwidth. The notified bandwidth is notified to a further next station (station C) on the upstream side. If there is no congestion, a fairness frame indicating a current transfer rate (bandwidth in-use) is notified periodically to the station on the upstream side.

To realize the operation as described above, the fairness function executes, in each station, detection of congestion, detection of a bandwidth to be secured, creation and transmission of a fairness frame, adjustment of a bandwidth to be used based on a notified bandwidth, transfer of the fairness frame, detection of a current transfer rate, and the like. For example, the fairness function is realized by execution of a program stored in a storage device (memory) by a processor such as a CPU disposed in the station (RPR device).

In the example shown in FIG. 2, a bandwidth above 2.4 Mbps and equal to or less than 9.6 Gbps is allocated, as an extended reserved bandwidth, to the section 1. A bandwidth above 622 Mbps (precisely OC-12 (optical carrier-level 12 =622.08 Mbps)) and equal to or less than 2.4 Gbps is allocated, as a common reserved bandwidth, to the sections 1 to 4. Then, a bandwidth equal to or less than 622 Mbps is allocated, as unreserved bandwidth, to each of the sections 1 to 4. The fairness function described above is applied to the unreserved bandwidth, and a bandwidth (occupied part) to be used in each station of the unreserved bandwidth is adjusted according to the fairness algorithm.

Information of the bandwidth allocated to each section is stored in the storage device installed in the station (RPR device), and used when a processor (CPU or the like) disposed in the station (RPR device) executes the program to determine a bandwidth to be used for frame transmission.

Each station includes a determination unit 50. In the case of transmitting frames to the other station, the determination unit 50 gives consideration to the bandwidth allocated to one or more sections through which the frame passes (flows) to reach the destination station, and determines a transmission bandwidth to be used for the frame transmission, within a range that a minimum value of the bandwidths allocated to the one or more sections becomes an upper limit of the transmission bandwidth (so that a minimum value of the bandwidths allocated to the one or more sections becomes an upper limit of the transmission bandwidth) . The determination unit 50, for example, determines the transmission bandwidth in the following manner at the time of starting frame transmission.

<1>The determination unit 50 specifies a destination station of a frame (which can be specified from a destination MAC address of an RPR frame), and specifies one or more sections through which the frame passes to reach the destination station.

<2> Next, the determination unit 50 refers to information indicating a bandwidth allocation state for each section stored in the storage device to determine a minimum value of a bandwidth in the sections passed through. At this time, if there is only one section to be passed through, a bandwidth allocated to the section is determined to be the minimum value.

For example, in the case of transmitting a frame from the station A to the station B by using the route 20-1, 9.6 Gbps allocated to the section 1 becomes a minimum value. Alternatively, in the case of transmitting a frame from the station A to the station C by using the route 20-1, the bandwidths of the sections 1 and 2 are referred to, and 2.4 Gbps allocated to the section 2 is determined to be the minimum value.

<3> After the minimum value has been determined, the determination unit 50 sets this minimum value as an upper limit, and determines a transmission bandwidth to be used for the frame transmission. For example, the determination unit 50 determines and secures a bandwidth to be used for each area set in the section to which the minimum value bas been allocated. For example, in the case of determining a transmission bandwidth based on the section 2, usable bandwidths are secured from a reserved rate (CIR) area and an unreserved rate (EIR) area constituting the bandwidth of the section 2, and a total of these bandwidths are set as the transmission bandwidth.

Then, a frame is sent to the ring 20 by the transmission bandwidth determined by the determination unit 50. The determination unit 50 can be constituted as a function to be realized by execution of the program by the processor disposed in the RPR device.

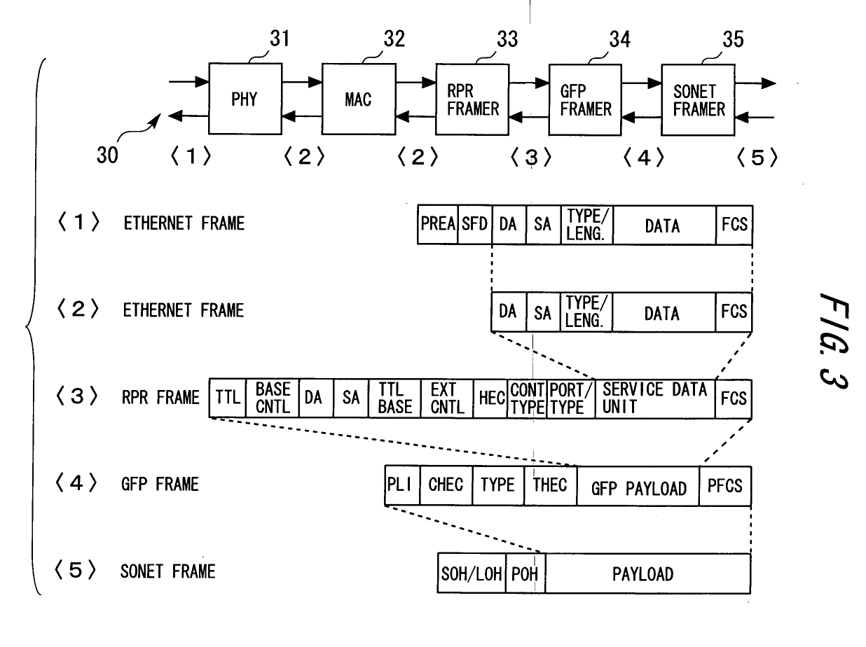

FIG. 3 is a diagram showing a functional block of a station applicable as each of the stations A to D, and formats of frames transferred between the functional blocks. In FIG. 3, a station 30 includes a physical layer processing unit (PHY) 31, a MAC processing unit (MAC) 32, an RPR framer 33, a generic framing procedure (GFP) framer 34, and a SONET framer 35.

The PHY 31 receives an Ethernet frame (referred to as “LAN frame” hereinafter) from the external network, and executes processing for the physical layer. The PHY 31 inputs a LAN frame (<2> of FIG. 3) obtained by removing a preamplifier and a start frame delimiter (SFD) from the received LAN frame (<1> of FIG. 3) to the MAC 32.

The MAC 32 executes processing regarding data link layers (LLC and MAC) for the LAN frame, and then inputs the LAN frame to the RPR framer. The RPR framer 33 generates an RPR frame (<3> of FIG. 3), in which the input LAN frame (<2> of FIG. 3) is stored (encapsulated) in a data unit (service data unit), and inputs the RPR frame to the GFP framer 34.

The GFP framer 34 generates a GFP frame (<4> of FIG. 3), in which the RPR frame is stored in a payload, and inputs the GFP frame to the SONET framer 35. The SONET framer 35 generates a SONET frame (<5> of FIG. 3), in which the GFP frame is stored, and outputs the SONET frame. The SONET frame output from the SONET framer 35 is sent (added) to the ringlet.

The SONET frame taken (dropped) out from the ringlet is input to the SONET framer 35. Subsequently, the aforementioned processing is executed in reverse. At the end, the LAN frame (<1> of FIG. 3) is output from the PHY 31, and sent to the external network.

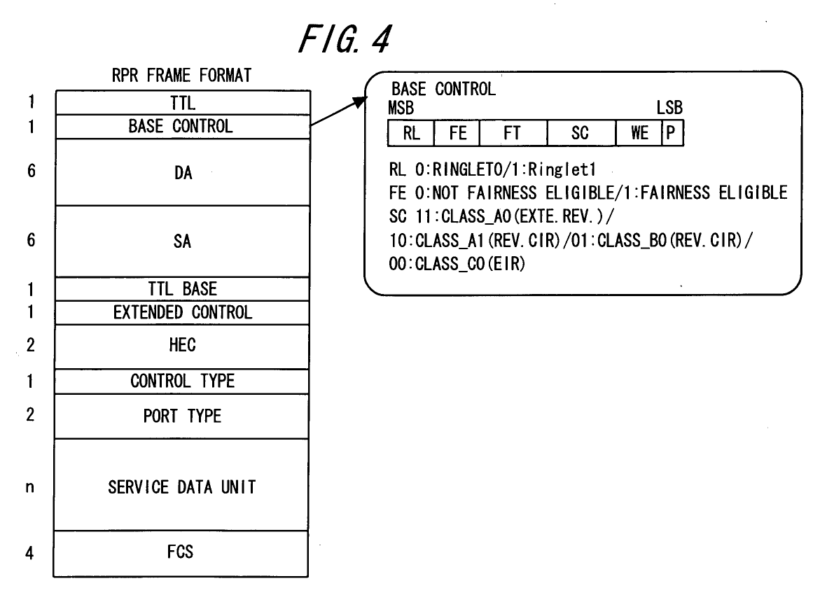

FIG. 4 is an explanatory diagram of a format of the RPR frame generated by the RPR framer 33. In FIG. 4, a base control field of the RPR frame contains an “RL” bit, an “FE” bit, and an “SC” bit.

The “RL” bit functions as a ringlet identifier. The “RL” bit includes 1 bit, a value “0” indicates sending to the ringlet 0, and a value 1 indicates sending to the ringlet 1.

The “FE” bit functions as an identifier to indicate presence of application of fairness control. The “FE” bit includes 1 bit. A value “0” of the “FE” bit indicates “not fairness eligible”, and a value 1 indicates “fairness eligible”.

The “SC” bit functions as a bandwidth class identifier of the RPR frame. The “SC” bit includes 2 bits. A value “11” of the “SC” bit indicates that the RPR frame is a frame allocated to an extended reserved bandwidth. Values “10” and “01” of the “SC” bit indicate that the RPR frame is a frame allocated to a reserved bandwidth. A value “00” of the “SC” bit indicates a frame in which the RPR frame is allocated to an unreserved bandwidth.

The values of these “RL”, “FE” and “SC” are determined by the RPR framer 33 and stored in the RPR framer 33. When the RPR frame is allocated to the unreserved bandwidth, values of the “RL”, “FE” and “SC” are respectively determined to be “0/1”, “1” and “00”.

When the RPR frame is allocated to the reserved bandwidth, values of the “RL”, “FE” and “SC” are respectively determined to be “0/1”, “0” and “10/01”. When the RPR frame is allocated to the extended reserved bandwidth, values of the “RL”, “FE” and “SC” are respectively determined to be “0/1”, “0” and “11”.

When the station starts transmission of the RPR frame, a bandwidth necessary for the transmission of the RPR frame is secured. At this time, according to types of bandwidths allocated to sections to be passed through by the RPR frame until it reaches a destination station, a bandwidth to be used is selected from usable types of bandwidths (areas) and secured.

For example, in the case of transmitting the RPR frame from the station 1 to the station 2 by using the section 1, the section 1 is permitted to use the extended reserved bandwidth (refer to FIG. 2). Thus, the station 1 select bandwidths used for transmitting the RPR frame from the extended reserved bandwidth and the reserved bandwidth to secured the bandwidth.

In this case, as the extended reserved bandwidth is allocated to the section 1 alone, entire of the extended reserved bandwidth can be secured as bandwidths to be used. On the other hand, regarding the reserved bandwidth, a predetermined bandwidth secured in advance, or a bandwidth to be secured at the time is secured as the bandwidth to be used.

Moreover, a bandwidth permitted by the fairness algorithm can be secured from the unreserved bandwidth as the bandwidth to be used. Accordingly, a total of the bandwidths to be used which have been secured from the extended reserved bandwidth, the reserved bandwidth and the unreserved bandwidth becomes a transmission rate (transmission bandwidth) of the RPR frame.

The RPR framer 33 sets corresponding bit values in the base control field (FIG. 4) of the RPR frame to be transmitted according to the bandwidths to be used which have respectively been selected to be secured from the extended reserved bandwidth, the reserved bandwidth, and the unreserved bandwidth. The determination of the bandwidths to be used can be performed for each ringlet when the same RPR frame is sent to both of the ringlets 0 and 1.

When the same RPR frame is sent to the ringlets 0 and 1, the RPR framer 33 of the embodiment can send the RPR frame to the ringlets 0 and 1 at different transmission rates.

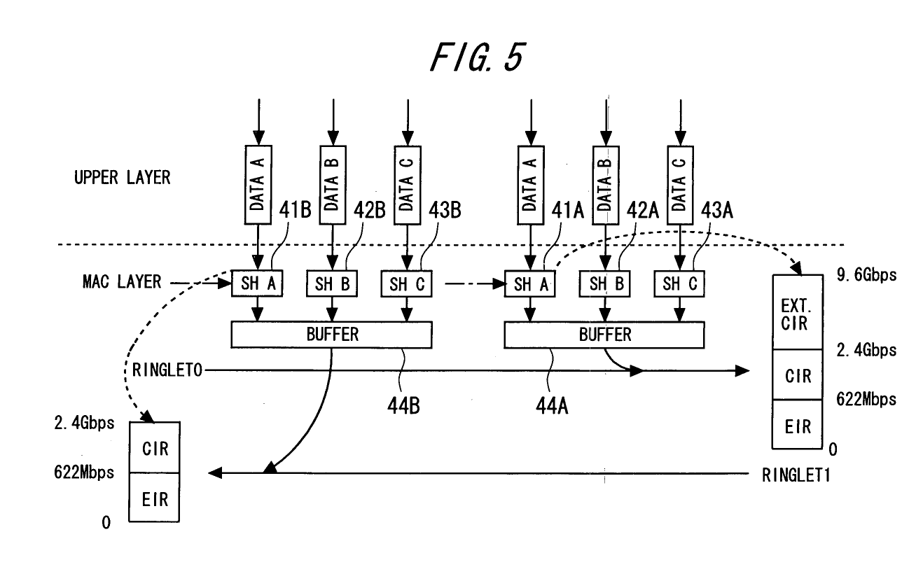

FIG. 5 is a diagram schematically showing a configuration of a part (bandwidth control part) of the RPR framer 33 shown in FIG. 3. FIG. 5 shows shapers 41A, 42A, 43A, 41B, 42B and 43B, and buffers 44A and 44B. The shapers 41A, 42A, 43A, 41B, 42B, and 43B and the buffers 44A and 44B are disposed in the RPR framer 33. The shapers 41A, 42A and 43A and the buffer 44A are prepared for the ringlet 0, while the shapers 41B, 42B and 43B and the buffer 44B are prepared for the ringlet 1.

In the example of FIG. 5, the number of shapers prepared corresponds to a priority order of data. In the example of FIG. 5, a priority order of three stages (e.g., priority order 1, 2 and 3) is defined, and three shapers are prepared for each ringlet according to the priority order.

In FIG. 5, data from an upper layer is stored in the RPR frame with the RPR framer 33. In this case, in the RPR framer 33, bit values are set in the base control field.

Each shaper reads the bit values (“RL” bit, “FE” bit, and “SC” bit) set in the base control field of the RPR frame, and judges which of the extended reserved bandwidth, the reserved bandwidth and the unreserved bandwidth the RPR frame has been allocated to. Additionally, each shaper receives information on the bandwidths to be used which have been secured from the extended reserved bandwidth, the reserved bandwidth, and the unreserved bandwidth, as control information (refer to a chain line arrow of FIG. 5) The shaper writes a corresponding RPR frame in the buffer based on the information of the bandwidth to be used. The buffer is used as a transmission buffer.

For example, the control information is calculated by execution of the program by the processor installed in the station (RPR device), and input to the RPR framer 33, whereby the control information can be supplied to the shaper.

A specific operation is as follows. For example, description will be made particularly on the shapers 41A and 41B for processing an RPR frame of data A corresponding to the priority order 1. It is assumed that the configuration shown in FIG. 5 is included in the station A (FIG. 1) , and the RPR frame is sent from the station A to the station B by using the ringlets 0 and 1. Additionally, it is presumed that no frames are sent from the stations B, C, and D. Unlike the case of FIG. 5, it is presumed that the shapers 41A and 41B alone are operated.

In this case, the station A can secure entire of the extended reserved bandwidth, the reserved bandwidth, and the unreserved bandwidth (9.6 Gbps) as bandwidths to be used for the ringlet 0. On the other hand, the station A can secure all the reserved bandwidth and the unreserved bandwidth (2.4 Gbps) as bandwidths to be used for the ringlet 1. Information of the bandwidths to be used is input to the shapers 41A and 41B.

On the ringlet 0 side, the shaper 41A writes RPR frames, the number of which corresponds to the used bandwidths of the extended reserved bandwidth, the reserved bandwidth, and the unreserved bandwidth, in the buffer 44A based on the inputted information of the bandwidths to be used. Accordingly, the RPR frames of 9.6 Gbps are written in the buffer 44A. Each of the RPR frames written in the buffer 44A is read out by proper timing, stored in a SONET frame, and sent to the ringlet 0.

On the ringlet 1 side, as in the case of the ringlet 0 side, the shaper 41B writes RPR frames, the number of which corresponds to the used bandwidths of the reserved bandwidth and the unreserved bandwidth, in the buffer 44B based on the inputted information of the bandwidths to be used. Accordingly, the RPR frames of 2.4 Gbps are written in the buffer 44B. Each of the RPR frames written in the buffer 44B is read out by proper timing, stored in the SONET frame, and sent to the ringlet 1.

With this configuration, the station of the embodiment can determine different transmission rates (communication capacities) for the ringlets 0 and 1, and send RPR frames at the different transmission rates. For the limit (bandwidth control) of a flow rate by the shaper, control based on a configuration using hardware (value is provisionally set) and control by software can both be applied.

According to the RPR ring network system of the first embodiment discussed above, a physical bandwidth (optical fiber capacity) is added only to the section for which a communication capacity is desired to be increased, and signals can be transmitted/received while the existing ring network remain unchanged. Thus, an increase of entire costs can be suppressed to a necessary minimum.

Furthermore, since bandwidth control can be executed without changing the fairness algorithm based on an RPR standard, complex bandwidth control calculation is not necessary for control of the RPR device. Thus, it is possible to easily change a bandwidth only for e necessary place.

<Second Embodiment>

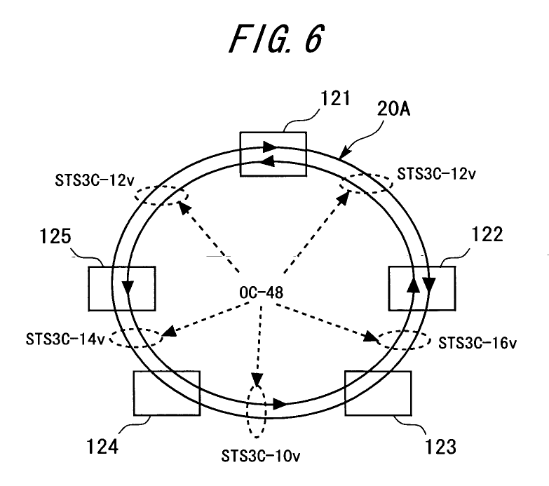

FIG. 6 is a diagram showing a configuration example of an RPR ring network system according to a second embodiment of the present invention. According to the first embodiment, the physical capacity is increased only for the section in which the bandwidth is desired to be increased. On the other hand, according to the second embodiment, all sections have equal physical capacities (e. g., OC-48 (2.4 Gbps)).

FIG. 6 shows the RPR ring network system where a plurality of stations 121, 122, 123, 124 and 125 are interconnected through a ring 20A. Adjacent stations (section) are connected to each other through a physical line of the OC-48. In other words, a bandwidth that 2.4 Gbps is an upper limit value can be allocated to each section. The second embodiment will be described by way of case where different bandwidth upper limit values are set in the respective sections.

FIG. 6 show an example of a bandwidth logically allocated to each section by using virtual concatenation. In the example shown in FIG. 6, with a concatenation synchronous transport signal level 3 (STS3C-nv) (n is a natural number) set as a bandwidth break unit, STS3C-12v, STS3C-16v, STS3C-10v, STS3C-14v, and STS3C-12v are respectively allocated as logical bandwidths between the stations 121 and 122, between the stations 122 and 123, between the stations 123 and 124, between the stations 124 and 125, and between the stations 125 and 121. In this case, the logical bandwidth allocation is indicated by the STS3C-nv. However, to control the allocation more finely, STS1-nv may be used as a break unit.

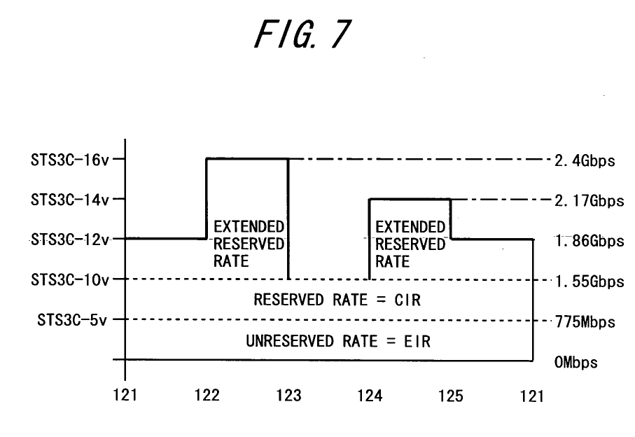

FIG. 7 is a diagram showing an allocated state of a bandwidth type to each section shown in FIG. 6. In an example shown in FIG. 7, a bandwidth up to STS3C-5v (775 Mbps) is allocated as an unreserved rate (EIR) area common to all the sections, and bandwidths from STS3C-5v to STS3C-10v (1.55 Gbps) are allocated as reserved rate (CIR) areas common to all the sections.

Further, bandwidths from STS3C-10v to STS3C-12v are allocated as extended reserved rate areas between the stations 121 and 122 and between the stations 125 and 121. A bandwidth from STS3C-10v to STS3C-14v (2.17 Gbps) is allocated as an extended reserved rate area between the stations 124 and 125. A bandwidth from STS3C-10v to STS3C-16v (2.4 Gbps) is allocated as an extended reserved rate area between the stations 122 and 123.

For a station configuration, the configuration of the first embodiment (FIGS. 3 and 5) can be applied. In other words, in a bandwidth control part in an RPR framer 33, RPR frames can be transmitted to the ringlets 0 and 1 at different transmission rates.

According to the second embodiment, through the RPR ring network, with a physical capacity set as an upper limit, it is possible to transmit/receive frames by allocating arbitrary (different) bandwidths to the sections. In this case, the same frame can be transmitted to the two ringlets at different transmission rates.

As described above, according to the first and second embodiment, in the communication network of Ethernet over SONET (EOS), when the resilient packet ring (RPR) device of Ethernet receives/transmits frames according to Recommendation of IEEE 802.17, it is possible to realize efficient communication by allocating a proper bandwidth to each section.

<Others>

The disclosure of Japanese Patent Application No. JP2005-102448 filed on Mar. 31, 2005 including the specification, drawings and abstract is incorporated herein by reference in its entirety.

What is claimed is:

1. An RPR ring network system comprising:
a plurality of resilient packet ring (RPR) station devices; and
a ring for interconnecting the plurality of RPR station devices,
wherein a section between adjacent RPR station devices is defined as a section of the ring, at least one section has a bandwidth different from bandwidths of other sections, and each of the RPR station devices determines a transmission bandwidth for transmitting frames to one of the RPR station devices through the ring so that an upper limit of the determined transmission bandwidth becomes a minimum value of a bandwidth allocated to each section that the frames will flow.

2. The RPR ring network system according to claim 1, wherein at least one of the sections has a physical capacity larger than those of the other sections, and each section has a bandwidth allocated within a range that a physical capacity of each section is an upper limit of the bandwidth.

3. The RPR ring network system according to claim 1, wherein all the sections have physical capacities equal to one another, and each section has a predetermined bandwidth is logically allocated within a range that a physical capacity becomes an upper limit of the predetermined bandwidth.

4. The RPR ring network system according to claim 1, wherein the ring includes two ringlets for transmitting frames in opposing directions, and when frames containing identical data are sent to the two ringlets, each RPR station device, when sending frames each including the same data to the two ringlets determines a transmission bandwidth based on a minimum value of a bandwidth allocated to each section of each ringlet through which the frames will flow.

5. The RPR ring network system according to claim 1, wherein a part or all of areas common to all the sections, which is included in the bandwidth allocated to each section, are controlled based on a fairness algorithm.

6. The RPR ring network system according to claim 1, wherein an area excluding areas common to all the sections, which is included in the bandwidth allocated to each section, is defined as a bandwidth to guarantee a bandwidth secured beforehand.
